(19) United States
(12) Patent Application Publication
(10) Pub. No.: US 2017/0044035 A1
(43) Pub. Date: Feb. 16, 2017

(54) OILFIELD WASTEWATER TREATMENT

(71) Applicants: Timothy Underwood, Houston, TX (US); Daryl D. McCracken, Houston, TX (US); Larry G. Hines, Odessa, TX (US); Chrysta S. Scurlark, Odessa, TX (US)

(72) Inventors: Timothy Underwood, Houston, TX (US); Daryl D. McCracken, Houston, TX (US); Larry G. Hines, Odessa, TX (US); Chrysta S. Scurlark, Odessa, TX (US)

(73) Assignee: BAKER HUGHES INCORPORATED, Houston, TX (US)

(21) Appl. No.: 14/823,316

(22) Filed: Aug. 11, 2015

(51) Int. Cl. C02F 1/72; C02F 1/68

(52) U.S. Cl. CPC C02F 1/722; C02F 1/682; C02F 2101/203

(57) ABSTRACT

A process for treating oilfield wastewater comprises oxidizing an oilfield wastewater having greater than about 1 ppm of a reducing agent comprising ferrous ions, a sulfide, a bisulfide, an organic compound, or a combination comprising at least one of the foregoing with an oxidant comprising hydrogen peroxide, potassium permanganate, chlorine, sodium hypochlorite, calcium hypochlorite, sodium percarbonate, sodium perborate, ozone, UV, oxygen, or a combination comprising at least one of the foregoing to provide an oxidized wastewater; and combining the oxidized wastewater with a biocide comprising chlorine dioxide.

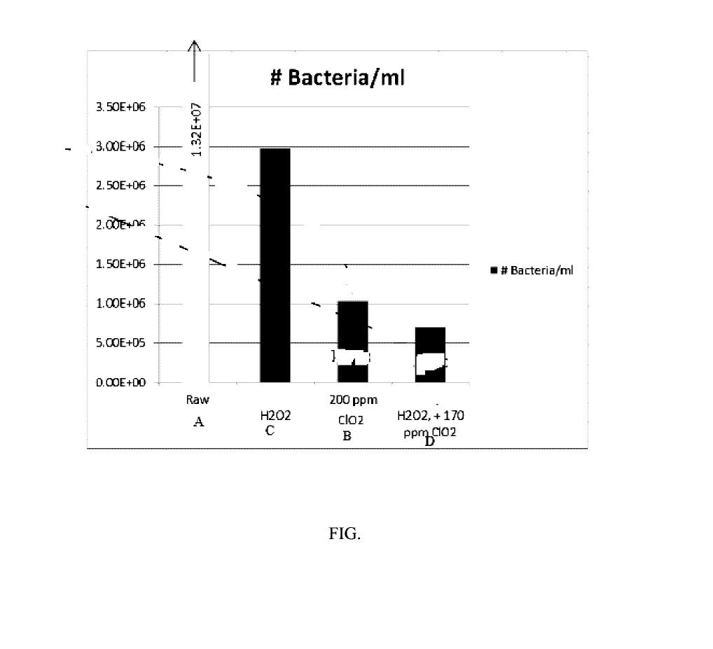

### BACKGROUND

In the oil and gas industry, wastewater is produced in large quantities as produced water, flowback water and the like. Oilfield wastewater can contain significant amounts of bacteria, which has to be removed or reduced to an acceptable level before the wastewater is disposed or reused. Biocides have been employed in the past for this purpose. However, in view of the large volume of wastewater to be treated on a daily basis, the art would well receive cost effective and efficient alternative processes to treat oilfield wastewater.

### BRIEF DESCRIPTION

A process for treating oilfield wastewater comprises oxidizing an oilfield wastewater having greater than about 1 ppm of a reducing agent comprising ferrous ions, a sulfide, a bisulfide, an organic compound, or a combination comprising at least one of the foregoing with an oxidant comprising hydrogen peroxide, potassium permanganate, chlorine, sodium hypochlorite, calcium hypochlorite, sodium percarbonate, sodium perborate, ozone, UV, oxygen, or a combination comprising at least one of the foregoing to provide an oxidized wastewater; and combining the oxidized wastewater with a biocide comprising chlorine dioxide.

A process for recycling oilfield wastewater comprises oxidizing an oilfield wastewater having greater than about 1 ppm of a reducing agent comprising ferrous ions, a sulfide, a bisulfide, an organic compound, or a combination comprising at least one of the foregoing with an oxidant comprising hydrogen peroxide, potassium permanganate, chlorine, sodium hypochlorite, calcium hypochlorite, sodium percarbonate, sodium perborate, ozone, UV, oxygen, or a combination comprising at least one of the foregoing to provide an oxidized wastewater; combining the oxidized wastewater with a biocide comprising chlorine dioxide to form recycled water; and disposing the recycled water in a subterranean environment.

### BRIEF DESCRIPTION OF THE DRAWINGS

The following descriptions should not be considered limiting in any way. With reference to the accompanying drawings, like elements are numbered alike:

The FIGURE (FIG.) shows the bacteria count for wastewater treated with H₂O₂ alone, wastewater treated with ClO₂ alone, and wastewater treated with H₂O₂ followed by ClO₂.

### DETAILED DESCRIPTION

The inventors hereof have found a cost effective process to treat oilfield wastewater containing high levels of reducing agents such as ferrous ion and H₂S. Chlorine dioxide is an effective biocide. However, when chlorine dioxide is used to treat wastewater containing high levels of reducing agents, chlorine dioxide reacts with the reducing agents first before it is available to act as a biocide. Accordingly, chlorine dioxide alone is not efficient in reducing bacteria in wastewater containing high levels of reducing agents. Hydrogen peroxide, potassium permanganate, and bleach are very economical oxidants, but have poor biocidal efficacy compared to ClO₂, and can have adverse reactions in fracture fluid formulation.

Applicants have found that the efficiency of the biocidal treatment process can be greatly improved if the wastewater is treated with an oxidant to oxidize the reducing agents first before the wastewater is treated with chlorine dioxide. The process is more cost effective. It reduces or eliminates bacteria in oilfield wastewater and renders the treated water storable, disposable, or re-useable as an oilfield fluid.

In an embodiment, a process for treating oilfield wastewater comprises: oxidizing an oilfield wastewater having greater than about 1 ppm of a reducing agent with an oxidant to provide an oxidized wastewater; and combining the oxidized wastewater with a biocide comprising chlorine dioxide.

The reducing agent includes ferrous ions, a sulfide such as H₂S, a bisulfide, an organic compound, or a combination comprising at least one of the foregoing. Exemplary organic compounds include but are not limited to those that contain sulfur, secondary or tertiary amines, phenols, and cyanides. The untreated oilfield waste water contains greater than about 1 ppm, greater than about 5 ppm, greater than about 10 ppm, greater than about 20 ppm, greater than about 50 ppm, greater than about 100 ppm, or greater than about 200 ppm of the reducing agent. In exemplarily embodiments, the untreated wastewater contains greater than about 1 ppm, greater than about 5 ppm, greater than about 10 ppm, greater than about 20 ppm, greater than about 50 ppm, greater than about 100 ppm, or greater than about 200 ppm of ferrous ions.

The oxidant comprises hydrogen peroxide, potassium permanganate, chlorine, sodium hypochlorite, calcium hypochlorite, sodium percarbonate, sodium perborate, ozone, ultraviolet light (UV), oxygen, for example air, or a combination comprising at least one of the foregoing. Preferably, the oxidant comprises hydrogen peroxide. In an embodiment, the oxidant comprises an aqueous solution of hydrogen peroxide wherein the hydrogen peroxide is present in an amount of about 10 wt. % to about 40 wt. % or about 15 wt. % to about 35 wt. %, based on a total weight of the solution.

The oxidant can be combined with wastewater to form an oxidized wastewater. The oxidant is added to the wastewater in such an amount that the oxidized wastewater contains less than about 15 ppm, less than about 10 ppm, less than about 5 ppm, less than about 2 ppm, or less than about 1 ppm, of the reducing agent. In an embodiment, the oxidized wastewater contains no detectable amount of the reducing agent. Specifically, the oxidant is added to the wastewater in such an amount that the oxidized wastewater contains less than about 15 ppm, less than about 10 ppm, less than about 5 ppm, less than about 2 ppm, or less than about 1 ppm of ferrous ions. In an embodiment, the oxidized wastewater contains no detectable amount of ferrous ions when measured using an atomic absorption spectrometry or a colorimetric method.

The oxidization can occur in about a few days to about a few minutes. After the reducing agent is oxidized, a biocide such as chlorine dioxide is added to the oxidized wastewater.

In an embodiment, a solution of chlorine dioxide is combined with oxidized wastewater. The solution of chlorine dioxide refers to an aqueous solution of chlorine dioxide, which contains an aqueous carrier and chlorine dioxide dissolved in the aqueous carrier. The aqueous carrier can comprise water or brine. The solution contains greater than about 500 ppm, greater than about 1,000 ppm, or greater than about 2,000 ppm of chlorine dioxide, based on the total weight of the chlorine dioxide solution. In an embodiment, the solution contains less than about 5 wt. % , less than about 1.0 wt. %, or less than about 0.5 wt. %, of chlorine dioxide, based on the total weight of the chlorine dioxide solution.

Additional oxidative biocide or non-oxidative biocide is optionally used together with chlorine dioxide. Exemplary oxidizing biocides include hypochlorite bleach (e.g., calcium hypochlorite and lithium hypochlorite), peracetic acid, potassium monopersulfate, potassium peroxymonosulfate, bromochlorodimethylhydantoin, dichloroethylmethylhydantoin, chloroisocyanurate, tris hydroxymethyl phosphine, trichloroisocyanuric acids, dichloroisocyanuric acids, 1-(3-chloroallyl)-3,5,7,-triaza-1-azonia-adamantane chloride, 1,2-benzisothiazolin-3-one, chlorinated hydantoins, and the like. Additional oxidizing secondary biocides include, e.g., bromine products such as: sodium hypobromite, ammonium bromide, sodium bromide, or brominated hydantoins such as 1-bromo-3-chloro- 5,5-dimethylhydantoin. Other oxidizing secondary biocides include chlorine, chlorine dioxide, chloramine, ozone, inorganic persulfates such as ammonium persulfate, or peroxides, such as hydrogen peroxide and organic peroxides.

Exemplary non-oxidizing biocides include dibromonitfilopropionamide, thiocyanomethylthiob enzothlazole, methyldithiocarbamate, tetrahydrodimethylthladiazonethione, tributyltin oxide, bromonitropropanediol, bromonitrostyrene, methylene bisthiocyanate, chloromethylisothlazolone, methylisothiazolone, benzisothlazolone, dodecylguanidine hydrochloride, polyhexamethylene biguanide, tetrakis(hydroxymethyl) phosphonium sulfate, glutaraldehyde, alkyldimethylbenzyl ammonium chloride, didecyldimethylammonium chloride, 2,2-dibromo-3-nitrilopropionamide, poly[oxyethylene-(dimethyliminio) ethylene (dimethyliminio) ethylene dichloride], decylthioethanamine, terbuthylazine, and the like. Additional non-oxidizing secondary biocides are quaternary ammonium salts, aldehydes, and quaternary phosphonium salts. In an embodiment, quaternary biocides have a fatty alkyl group and three methyl groups, but in the phosphonium salts, the methyl groups, e.g., are substituted by hydroxymethyl groups without substantially affecting the biocidal activity. In an embodiment, they also are substituted with an aryl group. Further examples of the secondary biocide includes glyoxal, furfural, acrolein, methacrolein, propionaldehyde, acetaldehyde, crotonaldehyde, pyridinium biocides, benzalkonium chloride, cetrimide, cetyl trimethyl ammonium chloride, benzethonium chloride, cetylpyridinium chloride, chlorphenoctium amsonate, dequalinium acetate, dequalinium chloride, domiphen bromide, laurolinium acetate, 2,6-dimethyl-m-dioxan-4-ol acetate, methylbenzethonium chloride, myristyl-gamma-picolinium chloride, ortaphonium chloride, triclobisonium chloride, alkyl dimethyl benzyl ammonium chloride, cocodiamine, dazomet, 1-(3-chloroallyl)-chloride.3,5,7-triaza-1-azoniaadamantane, 5-chloro-2-methyl-4-isothiazolin-3-one, 2-methyl-4-isothiazolin-3-one, 2-methyl-4-isothiazolin-3-one, tris(hydroxmethyl) nitromethane, or a combination thereof.

A combination of any of the foregoing biocides is useful together as long as the combination does not negatively affect reuse of the biocide treated water or render the biocide inactive or substantially inactive with respect to reducing or eliminating the bacteria in the oilfield wastewater.

The biocide is present in the oxidized wastewater in an amount effective to decrease a number density of living bacteria in the oilfield wastewater. In an embodiment, the number density of the live bacteria present in the biocide treated water decreases by an amount greater than or equal to about 90%, based on the number of bacteria per milliliter of the untreated oilfield wastewater.

In an embodiment, the biocide is added to the oilfield in an amount from 0.5 parts per million (ppm) to 20,000 ppm, specifically from 1 ppm to 10,000 ppm, and more specifically from 1 ppm to 500 ppm, based on a volume of the oxidized wastewater.

As an alternative to using ppm as a measure of the amount of the biocide in the oilfield wastewater, a proxy for the amount of the biocide is used. In an embodiment, the amount of the biocide is adjusted such that the an oxidation reduction potential (ORP) of the biocide treated water is greater than or equal to about 100 mV, about 200 mV, about 300 mV, about 400 mV, about 450 mV, about 500 mV, or about 600 mV, referenced to a Ag/AgCl reference electrode.

Optionally, the oxidized wastewater is subjected to a clarification. As used herein, clarification includes removal of solids from wastewater. According to an embodiment, a coagulant or flocculant is added to clarify the oxidized wastewater or the biocide treated water. In other words, a coagulant or flocculant is added after oxidation but before the biocide treatment or after addition of the biocide. The coagulant and the flocculant are nonionic, cationic, anionic, or zwitterionic.

The oilfield wastewater is a product of injecting water downhole or is formation water that flows from the formation to the surface. Exemplary oilfield waste water includes reservoir water, produced water, flowback water, settling pond water, water-flooding fluid, reserve pit water, or various recovered fluids such as drilling fluid, drilling mud, completion fluid, work over fluid, packer fluid, stimulation fluid, conformance control fluid, permeability control fluid, consolidation fluid, or a combination comprising at least one of the foregoing. Recovered fluids such as drilling fluid refer to any type of fluid pumped into a subterranean environment (e.g., a downhole, a borehole, a formation, and the like) during drilling, production, maintenance, or a restoration process. Produced water typically is water that flows to the surface during production of oil and gas from a subterranean hydrocarbon source. Flowback water, on the other hand, generally is water that flows to the surface after performing a hydraulic fracturing job. The oilfield wastewater contains a plurality of neutral and ionic species. In an embodiment, these elements are present as an ionic species that are hydrated, complexed, combined with another species, or a combination thereof The oilfield waste water also includes polyatomic species such as SO₄²⁻, HCO₃⁻, CO₃²⁻, H₂S, and the like as well as other components, including oil, grease, and dissolved solids.

The process disclosed herein has a number of uses including reuse of the biocide treated water (also referred to as recycled water) in various oilfield operations, disposal, storage, and the like. In an embodiment, a process for recycling oilfield wastewater includes forming biocide treated water or recycled water in a process as disclosed herein; and disposing the biocide treated water or recycled water in a subterranean environment.

Optionally, an additive is added to the recycled water to form a downhole treatment fluid before it is disposed downhole. The additive includes an acid (e.g., a mineral acid or organic acid), a biocide, a polymer, a breaker, a clay stabilizer, a corrosion inhibitor, a crosslinker, a friction reducer, a gelling agent, an iron control agent, a lubricant, a non-emulsifier, a pH-adjusting agent, a scale inhibitor, a surfactant, a proppant, or a combination comprising at least one of the foregoing. Such additives are thought to, for example, facilitate entry into rock formations, mitigate production or kill bacteria, reduce the risk of fouling, stabilize clay, provide well maintenance, facilitate proppant entry, improve surface pressure, provide proppant placement, prevent precipitation, reduce fluid tension of the composition, and the like. Suitable additives include those described in US2015/0013987.

In an embodiment, during injection of the downhole treatment fluid containing the recycled water in the subterranean environment, the treatment fluid is pressurized to fracture the subterranean environment. In some embodiments, the treatment fluid containing the recycled water is injected in the subterranean environment for stimulated production of a well, hydraulic fracturing, enhanced oil recovery, and the like. The treatment fluid containing the recycled water is, e.g., a hydraulic fracturing fluid comprising slickwater or a crosslink fluid; an enhanced oil recovery fluid; a completion fluid; a drilling fluid; or a combination comprising at least one of the foregoing. Exemplary treatment fluid containing recycled water also includes drilling mud, completion fluid, work-over fluid, packer fluid, stimulation fluid, conformance control fluid, permeability control fluid, consolidation fluid, and the like.

The process disclosed herein for biocidal treatment of oilfield wastewater and formation of treated water is further illustrated by the following non-limiting example.

### EXAMPLE

### Biocidal Treatment of Oilfield Wastewater

Four samples (Samples A, B, C, and D) of raw oilfield wastewater containing bacteria and 125 ppm of ferrous ions were acquired from the same oil well. Sample A was a control not treated with any biocide. Sample B was treated with 200 ppm ClO₂ based on the total weight of the sample. Sample C was treated with 75 ppm of hydrogen peroxide based on the total weight of the sample. Sample D was treated with 75 ppm of H₂O₂ followed by 170 ppm of ClO₂. An aliquot of Samples A-D was collected and subjected to ATP quantification. Thereafter, the number density of the bacteria was determined for Samples A-D. The results for each sample are shown in the Table below and the FIGURE. The data indicates that treatment of oilfield wastewater with hydrogen peroxide first followed by chlorine dioxide drastically decreases the number density of bacteria in the treated water as compared to using hydrogen peroxide alone or using chlorine dioxide alone.

TABLE

| | | | | | | Conversion |
|---|---|---|---|---|---|---|
| | | | | | | to # |
| | | Raw Data | | | Cellular ATP | of bacteria |
| Sample | Sample | UltraCheck | Sample | Volume | Pg of ATP | # of bacteria |
| ID | description | 1 RLU | RLU | (mL) | per ml | per ml |
| A | Raw | 17310 | 227959 | 10 | 13169.2 | 1.32E+07 |
| B | 200 ppm ClO2 | 17310 | 17974 | 10 | 1038.4 | 1.04E+06 |
| | ORP 650 | | | | | |
| C | 75 ppm H2O2 | 17310 | 51372 | 10 | 2967.8 | 2.97E+06 |
| D | 75 ppm | 17310 | 12097 | 10 | 698.8 | 6.99E+05 |
| | H2O2 + 17-ppm | | | | | |
| | ClO2 ORP 650 | | | | | |

All ranges disclosed herein are inclusive of the endpoints, and the endpoints are independently combinable with each other. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” Further, it should further be noted that the terms “first,” “second,” and the like herein do not denote any order, quantity (such that more than one, two, or more than two of an element can be present), or importance, but rather are used to distinguish one element from another. The modifier “about” used in connection with a quantity is inclusive of the stated value and has the meaning dictated by the context (e.g., it includes the degree of error associated with measurement of the particular quantity).

What is claimed is:

1. A process for treating oilfield wastewater, the process comprising:
oxidizing an oilfield wastewater having greater than about 1 ppm of a reducing agent comprising ferrous ions, a sulfide, a bisulfide, an organic compound, or a combination comprising at least one of the foregoing with an oxidant comprising hydrogen peroxide, potassium permanganate, chlorine, sodium hypochlorite, calcium hypochlorite, sodium percarbonate, sodium perborate, ozone, UV, oxygen, or a combination comprising at least one of the foregoing to provide an oxidized wastewater; and
combining the oxidized wastewater with a biocide comprising chlorine dioxide.

2. The process of claim 1, wherein the oilfield wastewater comprises greater than about 1 ppm of ferrous ions.

3. The process of claim 1, wherein the oilfield wastewater comprises greater than about 20 ppm of ferrous ions.

4. The process of claim 3, wherein oxidizing the oilfield wastewater comprises adding the oxidant to the oilfield wastewater in such an amount that the oxidized wastewater comprises less than about 10 ppm of ferrous ions.

5. The process of claim 3, wherein oxidizing the oilfield wastewater comprises adding the oxidant to the oilfield wastewater in such an amount that the oxidized oilfield wastewater comprises less than about 5 ppm of ferrous ions.

6. The process of claim 2, wherein oxidizing the oilfield wastewater comprises adding the oxidant to the oilfield wastewater in such an amount that the oxidized oilfield wastewater comprises no detectable amount of ferrous ions

7. The process of claim 1, wherein the oxidant comprises hydrogen peroxide.

8. The process of claim 1, wherein the oxidant is an aqueous solution comprising about 10 wt. % to about 40 wt. % of hydrogen peroxide based on a total weight of the aqueous solution.

9. The process of claim 1, wherein the biocide is an aqueous solution comprising 500 ppm to about 5 wt. % of chlorine dioxide, based on a total weight of the solution.

10. The process of claim 1, further comprising determining the number density of the bacteria present in the oilfield wastewater.

11. The process of claim 10, wherein combining the oxidized wastewater with the biocide comprises adding the biocide to the oxidized wastewater in an amount effective to reduce the number density of the live bacteria present in the oxidized water by an amount greater than or equal to about 90%, based on the number of bacteria per milliliter of the oilfield wastewater.

12. The process of claim 1, further comprising subjecting the oxidized wastewater to clarification before combining the oxidized wastewater with the biocide.

13. The process of claim 1, wherein the oilfield wastewater comprises reservoir water, produced water, flowback water, pit water, or a combination comprising at least one of the foregoing.

14. The process of claim 1 comprising:
oxidizing an oilfield wastewater comprising greater than about 50 ppm of ferrous ion with an oxidant comprising hydrogen peroxide in an amount sufficient to provide an oxidized oilfield wastewater having less than about 5 ppm of ferrous ions; and
combining the oxidized oilfield wastewater with a biocide comprising chlorine dioxide in an amount effective to form biocide treated water having an oxidization reduction potential of greater than about 100 mV referenced to an Ag/AgCl reference electrode.

15. A process for recycling oilfield wastewater, the process comprising: oxidizing an oilfield wastewater having greater than about 1 ppm of a reducing agent comprising ferrous ions, a sulfide, a bisulfide, an organic compound, or a combination comprising at least one of the foregoing with an oxidant comprising hydrogen peroxide, potassium permanganate, chlorine, sodium hypochlorite, calcium hypochlorite, sodium percarbonate, sodium perborate, ozone, UV, oxygen, or a combination comprising at least one of the foregoing to provide an oxidized wastewater;
combining the oxidized wastewater with a biocide comprising chlorine dioxide to form recycled water; and
disposing the recycled water in a subterranean environment.

16. The process of claim 15, wherein the oilfield wastewater comprises greater than 1 ppm of ferrous ions.

17. The process of claim 15, wherein oxidizing the oilfield wastewater comprises adding the oxidant to the oilfield wastewater in such an amount that the oxidized oilfield wastewater comprises less than 1 ppm of ferrous ions.

18. The process of claim 15, wherein the oxidant comprises hydrogen peroxide.

19. The process of claim 15 comprising:
oxidizing an oilfield wastewater comprising greater than about 50 ppm of ferrous ion with an oxidant comprising hydrogen peroxide in an amount sufficient to provide an oxidized oilfield wastewater having less than about 5 ppm of ferrous ion;
combining the oxidized oilfield wastewater with a biocide comprising chlorine dioxide in an amount effective to form recycled water having an having an oxidization reduction potential of greater than about 100 mV referenced to an Ag/AgCl reference electrode;
adding an additive to the recycled water to form a downhole treatment fluid; and
disposing the downhole treatment fluid in a subterranean environment.
